(19) United States
(12) Patent Application Publication
(10) Pub. No.: US 2012/0286217 A1
(43) Pub. Date: Nov. 15, 2012

(54) METHODS FOR MITIGATING AGGLOMERATION OF CARBON NANOSPHERES USING EXTRACTION

(75) Inventors: Cheng Zhang, Houston, TX (US); Bing Zhou, Titusville, NJ (US)

(73) Assignee: HEADWATERS TECHNOLOGY INNOVATION, LLC, Lawrenceville, NJ (US)

(21) Appl. No.: 13/106,496

(22) Filed: May 12, 2011

(51) Int. Cl. H01B 1/24; C01B 31/02; C01B 31/00; B82Y 99/00; B82Y 40/00

(52) U.S. Cl. 252/511; 423/461; 423/445 R; 977/897; 977/753

(57) ABSTRACT

Novel methods for manufacturing carbon nanostructures (e.g., carbon nanospheres) that are highly dispersed include forming a precursor composition, polymerizing the precursor composition, extracting water from the polymerized carbon material using an organic solvent, and carbonizing the polymerized material (e.g., through pyrolysis) to form the carbon nanostructures. The extraction-treated polymerized carbon material forms carbon nanostructures that are less agglomerated than carbon nanostructures manufactured using a similar technique without solvent extraction of water.

### BACKGROUND OF THE INVENTION

1. The Field of the Invention

The present invention relates generally to the manufacture of carbon nanomaterials. More particularly, the present invention relates to methods for manufacturing highly dispersed carbon nanospheres using extraction.

2. The Related Technology

Carbon materials have been used in a variety of fields as high-performance and functional materials. Pyrolysis of organic compounds is known to be a useful method for preparing carbon materials. For example, carbon materials can be produced by pyrolyzing resorcinol-formaldehyde gel at temperatures above 600° C.

Most carbon materials obtained by pyrolysis of organic compounds at temperatures between 600-1400° C. tend to be amorphous or have a disordered structure. Obtaining highly crystalline or graphitic carbon materials can be very advantageous because of the unique properties exhibited by graphite. For example, graphitic materials can be conductive and form unique nanomaterials such as carbon nanotubes. However, using existing methods it is difficult to make these well-crystallized graphite structures using pyrolysis, especially at temperatures less than 2000° C.

To acquire the graphitic structure at lower temperature, many studies have been carried out on carbonization in the presence of a metal catalyst. The catalyst is typically a salt of iron, nickel, or cobalt that is mixed with carbon precursor. Using catalytic graphitization, graphitic materials can be manufactured at temperatures between 600° C. and 1400° C.

Recently, this method has been used to manufacture carbon nanotubes and other carbon nanostructures. The carbon nanostructures are manufactured by mixing a carbon precursor with iron nanoparticles and carbonizing the precursor to cause the carbon nanostructure to grow from or around the iron nanoparticles. The iron nanoparticles are removed from the material by treating with strong acids. The amorphous carbon is typically removed using an oxidizing agent such as potassium permanganate.

### BRIEF SUMMARY OF THE INVENTION

The present invention relates to novel methods for manufacturing carbon nanostructures (e.g., carbon nanospheres) that have minimal agglomeration of particles and are highly dispersible in a solvent. The method includes forming a precursor composition, polymerizing the precursor composition, removing water from the polymerized carbon material using solvent extraction, and carbonizing the extraction treated carbon material (e.g., through pyrolysis) to form the carbon nanostructures. The solvent extraction step removes bound water from the polymerized carbon material. Surprisingly, performing solvent extraction to remove water prior to pyrolysis results in carbon nanostructures that are less agglomerated compared to similar methods in which water is removed by drying and/or evaporation.

In one embodiment, a method for manufacturing a carbon nanomaterial may include the steps of (i) providing a mixture including a carbon precursor and a catalytic metal and polymerizing the mixture to form a polymerized carbon material; (ii) extracting water from the polymerized carbon material using an organic solvent to yield an extraction-treated carbon material; (iii) carbonizing the extraction-treated carbon material to form an intermediate carbon material that includes carbon nanostructures, amorphous carbon, and catalytic metal; and (iv) purifying the intermediate carbon material by removing some or all of the amorphous carbon and catalytic metal.

The extraction is carried out using an organic solvent capable of displacing water bound to the polymerized carbon material. The organic solvent is not miscible with water such that water displaced by the organic solvent separates to form an aqueous phase. The organic solvent allows bound water to be extracted from the polymerized organic material and collected in an aqueous phase. Examples of suitable solvents include low molecular weight alcohols that are not miscible in water, but which may be somewhat soluble in water, including, but not limited to, butanol and pentanol; ** [**Please provide examples of additional solvents that can be used].

In one embodiment, the solvent extraction may be carried out by preparing a slurry of the organic solvent and the polymerized carbon material. The slurry may be heated to cause formation of an aqueous phase and an organic phase. The heating may continue until formation of additional aqueous phase ceases, thereby indicating complete extraction of the water by the organic solvent. Removing the aqueous phase from the polymeric carbon material yields the extraction-treated carbon material. The organic phase may also be removed by drying and/or evaporation. The extraction treated carbon material can be coated with fresh organic solvent (i.e., an organic solvent not used in the solvent extraction step). The fresh organic solvent may be the same or different than the organic solvent used in the extraction step.

Carbon nanomaterials manufactured using the methods of the invention tend to exhibit less agglomeration compared to carbon nanomaterials manufactured using similar techniques but without performing solvent extraction. The carbon nanomaterials manufactured using solvent extraction as described herein can be more easily blended with solvents and other materials due to the reduced agglomeration.

These and other advantages and features of the present invention will become more fully apparent from the following description and appended claims as set forth below.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a high resolution TEM image of carbon nanospheres manufactured according to the methods described herein.

### DETAILED DESCRIPTION OF EXAMPLE EMBODIMENTS

### I. Introduction and Definitions

The present invention is directed to methods for manufacturing carbon nanostructures (e.g., carbon nanospheres) using carbon precursors and carbonization. The formation of the carbon nanostructures is controlled in part by extracting bound water from the polymerized carbon material prior to carbonization. Residual interstitial water may also be removed at the same time. The absence of bound water during the carbonization step has been found to substantially reduce agglomeration in the purified carbon nanomaterials manufactured from the carbon precursor.

In one embodiment, the carbon nanostructures manufactured using the methods disclosed herein may produce carbon nanospheres. The carbon nanostructures may have a plurality of carbon layers forming a wall that generally appears to define a nanosphere. In one embodiment, the carbon nanostructure can be characterized as hollow but irregularly shaped multi-walled, sphere-like (or spheroidal) nanostructures when analyzed in view of SEM images in combination with TEM images of the same material. For purposes of this invention, the term “nanosphere” includes graphitic, hollow particles or balls that have an irregular outer shape and a hollow center surrounded by a graphitic wall.

### II. Components Used to Manufacture Carbon Nanostructures

The following components can be used to carry out the above mentioned steps for manufacturing carbon nanostructures according to the present invention.

A. Carbon Precursor

Any type of carbon material can be used as the carbon precursor of the present invention so long as it can form a solution with the catalytic metal and then carbonize upon heat treating. Suitable compounds include single and multi-ring aromatic compounds such as benzene and naphthalene derivatives that have polymerizable functional groups. Also included are ring compounds that can form single and multi-ring aromatic compounds upon heating. Functional groups that can participate in polymerization include COOH, C═O, OH, C═C, SO₃, NH₂, SOH, N═C═O, and the like.

The carbon precursor can be a single type of molecule (e.g., a compound that can polymerize with itself), or the carbon precursor can be a combination of two or more different compounds that co-polymerize together. For example, in an exemplary embodiment, the carbon precursor can be a resorcinol-formaldehyde gel. In this two compound embodiment, the formaldehyde acts as a cross-linking agent between resorcinol molecules by polymerizing with the hydroxyl groups of the resorcinol molecules.

Other examples of suitable carbon precursors include resorcinol, phenol resin, melamine-formaldehyde gel, poly(furfuryl alcohol), poly(acrylonitrile), sucrose, petroleum pitch, and the like. Other polymerizable benzenes, quinones, and similar compounds can also be used as carbon precursors and are known to those skilled in the art.

In an exemplary embodiment, the carbon precursor is a hydrothermally polymerizable organic compound. Suitable organic compounds of this type include citric acid, acrylic acid, benzoic acid, acrylic ester, butadiene, styrene, cinnamic acid, and the like.

B. Catalytic Metal Composition

Catalytic metals, preferably metal salts may be included in the carbon precursor composition. When mixed with the carbon precursor, the catalytic metal may serve as templating nanoparticles and/or nucleation site where carbonization and/or polymerization can begin or be enhanced.

The catalyst atom used to form the templating nanoparticles can be any material that can cause or promote carbonization and/or polymerization of the carbon precursor. In a preferred embodiment, the catalyst is a transition metal salt including but not limited to salts of iron, cobalt, or nickel. These transition metal catalysts are particularly useful for catalyzing many of the polymerization and/or carbonization reactions involving the carbon precursors described herein. The metal salts can be mixed into the precursor mixture as metal salts or can be provided as elemental (or ground state) metals that can be mixed with oxidizing agents to form metal salts in-situ.

(i) Dispersing Agents

Optionally, a dispersing agent can be complexed with the catalyst atoms to control formation of catalytic templating nanoparticles. The dispersing agent is selected to promote the formation of nanocatalyst particles that have a desired stability, size and/or uniformity. Dispersing agents within the scope of the invention include a variety of small organic molecules, polymers and oligomers. The dispersing agent is able to bond with catalyst atoms dissolved or dispersed within an appropriate solvent or carrier. The bonding may be ionic bonding, covalent bonding, Van der Waals interaction/bonding, lone pair electron bonding, or hydrogen bonding.

To provide the bonding between the dispersing agent and the catalyst atoms, the dispersing agent includes one or more appropriate functional groups. Preferred dispersing agents include functional groups which have either a charge or one or more lone pairs of electrons that can be used to complex a metal catalyst atom, or which can form other types of bonding such as hydrogen bonding. These functional groups allow the dispersing agent to have a strong binding interaction with the catalyst atoms.

The dispersing agent may be a natural or synthetic compound. In the case where the catalyst atoms are metal and the dispersing agent is an organic compound, the catalyst complex so formed may be an organometallic complex.

In one embodiment, the functional groups of the dispersing agent comprise one or more members selected from the group of a hydroxyl, a carboxyl, a carbonyl, an amine, an amide, a nitrile, a nitrogen with a free lone pair of electrons, an amino acid, a thiol, a sulfonic acid, a sulfonyl halide, or an acyl halide. The dispersing agent can be monofunctional, bifunctional, or polyfunctional.

Examples of suitable monofunctional dispersing agents include carboxylic acids such as formic acid and acetic acid. Useful bifunctional dispersing agents include diacids such as oxalic acid, malic acid, malonic acid, maleic acid, succinic acid, and the like; hydroxy acids such as glycolic acid, lactic acid, and the like. Useful polyfunctional dispersing agents include sugars such as glucose, polyfunctional carboxylic acids such as citric acid, pectins, cellulose, and the like. Other useful dispersing agents include ethanolamine, mercaptoethanol, 2-mercaptoacetate, amino acids, such as glycine, and sulfonic acids, such as sulfobenzyl alcohol, sulfobenzoic acid, sulfobenzyl thiol, and sulfobenzyl amine.

Suitable polymers and oligomers within the scope of the invention include, but are not limited to, polyacrylates, polyvinylbenzoates, polyvinyl sulfate, polyvinyl sulfonates including sulfonated styrene, polybisphenol carbonates, polybenzimidizoles, polypyridine, sulfonated polyethylene terephthalate. Other suitable polymers include polyvinyl alcohol, polyethylene glycol, polypropylene glycol, and the like.

In addition to the characteristics of the dispersing agent, it can also be advantageous to control the molar ratio of dispersing agent to the catalyst atoms in a catalyst suspension. A more useful measurement is the molar ratio between dispersing agent functional groups and catalyst atoms. For example, in the case of a divalent metal ion two molar equivalents of a monovalent functional group would be necessary to provide the theoretical stoichiometric ratio. In a preferred embodiment, the molar ratio of dispersing agent functional groups to catalyst atoms is preferably in a range of about 0.01:1 to about 100:1, more preferably in a range of about 0.05:1 to about 50:1, and most preferably in a range of about 0.1:1 to 20:1.

The dispersing agents of the present invention allow for the formation of very small and uniform nanoparticles. In general, the nanocatalyst particles formed in the presence of the dispersing agent are less than 1 micron in size. Preferably the nanoparticles are less than about 100 nm, more preferably less than about 50 nm and most preferably less than about 20 nm.

During pyrolysis of the carbon precursor, the dispersing agent can inhibit agglomeration and deactivation of the catalyst particles. This ability to inhibit deactivation can increase the temperature at which the nanocatalysts can perform and/or increase the useful life of the nanocatalyst in the extreme conditions of pyrolysis. Even if including the dispersing agent only preserves catalytic activity for a few additional milliseconds, or even microseconds, the increased duration of the nanocatalyst can be very beneficial at high temperatures, given the dynamics of carbonization.

(ii) Precursor Solvents and Other Additives

A solvent can optionally be used to prepare the catalyst atoms for mixing with the dispersing agent and/or the carbon precursor. The liquid medium in which the catalytic templating nanoparticles are prepared may contain various solvents, including water and organic solvents. Solvents participate in particle formation by providing a liquid medium for the interaction of catalyst atoms and dispersing agent. In some cases, the solvent may act as a secondary dispersing agent in combination with a primary dispersing agent that is not acting as a solvent. In one embodiment, the solvent also allows the nanoparticles to form a suspension. Suitable solvents include water, methanol, ethanol, n-propanol, isopropyl alcohol, acetonitrile, acetone, tetrahydrofuran, ethylene glycol, dimethylformamide, dimethylsulfoxide, methylene chloride, and the like, including mixtures thereof.

The catalyst precursor composition can also include additives to assist in the formation of the nanocatalyst particles. For example, mineral acids and basic compounds can be added, preferably in small quantities (e.g., less than 5 wt %). Examples of mineral acids that can be used include hydrochloric acid, nitric acid, sulfuric acid, phosphoric acid, and the like. Examples of basic compounds include sodium hydroxide, potassium hydroxide, calcium hydroxide, ammonium hydroxide, and similar compounds.

It is also possible to add solid materials to assist in nanoparticle formation. For example, ion exchange resins may be added to the solution during catalyst formation. Ion exchange resins can be substituted for the acids or bases mentioned above. Solid materials can be easy separated from the final iron catalyst solution or suspension using simple techniques such as centrifugation and filtration.

C. Extraction Solvents

The organic solvent used for extracting water from the polymerized organic material can be any organic solvent that is not miscible in water and can displace bound water in the polymerized carbon material. They include solvents that may be slightly water soluble but not miscible (i.e., able to form a homogeneous aqueous mixture in all proportions). In one embodiment, the solubility of the organic solvent in water is less than 12.5 g/ml at 20° C.

Examples of suitable extraction solvents include organic solvents having a hydrophobic carbon chain of at least 4 carbons and a functional group capable of interacting with hydroxyl groups on the surface of the polymerized carbon material. Suitable functional groups capable of interacting with the surface of the polymerized carbon material include alcohols and thiols. In one embodiment the organic solvent can be a low molecular weight alcohol having 4 or 5 carbons; butanol is preferred.

[**Please confirm completeness of the description of the organic solvent used in extraction and/or provide additional examples of suitable solvents]

D. Reagents for Purifying Intermediate Carbon Materials

Various reagents can be used to remove amorphous carbon and/or the catalytic metals from the carbon nanostructures, thereby purifying the intermediate material. The purification can be carried out using any reagent or combination of reagents capable of selectively removing amorphous carbon (or optionally catalytic metal) while leaving graphitic material.

Reagents for removing amorphous carbon include oxidizing acids and oxidizing agents and mixtures of these. An example of a mixture suitable for removing amorphous carbon includes sulfuric acid, KMnO₄, H₂O₂, 5M or greater HNO₃, and aqua regia.

The catalytic metal can be removed using any reagent that can selectively dissolve the particular metal used as the catalyst without significantly destroying the carbon nanostructures, which are graphitic. Nitric acid is an example of a reagent suitable for dissolving many base transition metals such as, but not limited to, iron, cobalt, and nickel. Other examples of suitable reagents include hydrogen fluoride, hydrochloric acid, and sodium hydroxide.

### III. Manufacturing Carbon Nanostructures

The carbon nanostructures of the present invention can be manufactured using all or a portion of the following steps: (i) providing a precursor mixture including a carbon precursor and a catalyst precursor composition including a catalytic metal and an organic dispersing agent; (ii) polymerizing the precursor mixture to form a polymerized carbon material; (iii) extracting water from the polymerized carbon material using an organic solvent to yield an extraction-treated carbon material; (iv) carbonizing the extraction-treated carbon material to form an intermediate carbon material comprising a plurality of carbon nanostructures, amorphous carbon, and catalytic metal; and (v) purifying the intermediate carbon material by removing at least a portion of the amorphous carbon and at least a portion of the catalytic metal.

A. Forming a Precursor Mixture

The precursor mixture is formed by selecting a carbon precursor, a catalytic metal, and optionally solvents and/or other additives. The components of the precursor solution can be prepared as separate solutions and mixed together or they can be added all together or in any combination.

In one embodiment, the catalytic metals can be formed into catalytic precursor solution, which may form catalytic nanoparticles before or after being dispersed in the carbon precursor. In this embodiment, the catalyst precursor solution may be formed by selecting one or more catalyst metal salts that can be mixed with a solvent and then mixed with the carbon precursor.

If desired templating particles may be formed (in-situ or ex-situ) using an organic complexing agent. The organic complexing agents may facilitate controlling particle formation and therefore catalytic activity. Examples of suitable organic complexing agents include compounds having carboxylic acid groups that can complex with the metal atoms (e.g., glycolic acid, citric acid, glycine, and polyacrylic acid).

B. Polymerizing the Precursor Mixture

Polymerization may be conducted using a curing agent and/or heat. The precursor mixture is typically allowed to cure for sufficient time to form a matrix of carbon polymers and dispersed catalytic metal atoms or particles.

For hydrothermally polymerizable carbon precursors, polymerization typically occurs at elevated temperatures. In a preferred embodiment, the carbon precursor is heated to a temperature of about 0° C. to about 200° C., and more preferably between about 25° C. to about 120° C.

An example of a suitable condition for polymerization of resorcinol-formaldehyde gel (e.g., with iron particles and a solution pH of 1-14) is a solution temperature between 0° C. and 90° C. and a cure time of less than 1 hour to about 72 hours. Those skilled in the art can readily determine the conditions necessary to cure other carbon precursors under the same or different parameters.

The polymerization may be carried out by adding ammonia to adjust the pH, which increase the rate of polymerization by increasing the amount of cross linking that occurs between precursor molecules.

In some embodiments, the catalytic metal may form particles and the carbon precursor may polymerize around the templating nanoparticles. However, in other embodiments, the catalytic metals may be merely dispersed in the carbon precursor material.

The polymerized carbon material is typically wet upon completion of the polymerization reaction. The wet polymerized carbon material can be used as is in the subsequent extraction step (i.e., without drying).

C. Extracting Water Using an Organic Solvent

The wet polymerized carbon material is treated using solvent extraction to remove bound and/or interstitial water that remains in the polymerized carbon material from the polymerization reaction and/or water in the precursor solutions. The water extraction step is carried out after polymerization but before carbonization.

Solvent extraction may be performed by selecting an appropriate organic solvent and mixing it with the polymerized carbon material (e.g., to form a slurry). The solvent polymer mixture is then heated to form an aqueous phase and an organic phase. Heating can be carried out at a temperature in a range from about ** to **, preferably ** to about **, and more preferably about ** to about **. [**Please provide temperature ranges for performing the solvent extraction.] The aqueous phase forms as the organic solvent displaces free water and/or bound water on the surface or interior of the polymerized carbon material. Heating is allowed to continue until the extraction is essentially complete. Completion of the extraction typically occurs when the heating process ceases to result in formation of additional water in the aqueous phase, thereby indicating that essentially all the water has been removed by extraction. In one embodiment, the reaction is allowed to proceed for at least about ** h, preferably at least about ** h, and more preferably at least about ** h. [**Please provide duration of heating]

In one embodiment, extraction can include the use of reflux to help liberate or release bound water. In this embodiment, heating the mixture of organic solvent and polymerized carbon material produces a vapor that can be condensed to produce the aqueous phase and the organic phase. The organic phase and the aqueous phase can be separated using a separatory funnel, centrifuge, or other separatory device suitable for separating an aqueous phase from an organic phase. Removing the aqueous phase from the polymerized carbon material yields an extraction-treated carbon material that is substantially free of water (i.e., includes less than about 1% water, preferably less than about 0.5% water, more preferably less than about 0.25% water).

The extraction-treated carbon material may be further processed to remove residual organic solvent. The organic solvent can be removed by decanting, extracting, and/or drying. Drying can be performed using a vacuum and/or oven. Drying is advantageously carried out below the carbonization temperature of the polymerized material, preferably below 500° C., more preferably below about 250° C., and most preferably below about 100° C.

After drying to remove organic solvent utilized during extraction, the extraction-treated carbon material can be treated with fresh organic solvent (i.e., organic solvent not utilized in the extraction process). The fresh organic solvent can coat the surface of the polymerized carbon and minimize agglomeration during the carbonization step.

Examples of suitable organic solvents include the extraction solvents. The fresh organic solvent may be the same or a different organic solvent than the organic solvent used to perform the extraction.

D. Carbonizing the Precursor Mixture

The extraction-treated carbon material is carbonized by heating to form an intermediate carbon material that includes a plurality of carbon nanostructures, amorphous carbon, and catalyst metal. The extraction-treated carbon material can be carbonized by heating the mixture to a temperature between about 500° C. and about 2500° C. During the heating process, atoms such as oxygen and nitrogen are volatilized or otherwise removed from the intermediate nanostructures (or the carbon around the templating nanoparticles) and the carbon atoms are rearranged or coalesced to form a carbon-based structure.

The carbonizing step typically produces a graphite based nanostructure. The graphite based nanostructure has carbon atoms arranged in structured sheets of sp² hybridized carbon atoms. The graphitic layers can provide unique and beneficial properties, such as electrical conduction and structural strength and/or rigidity.

E. Purifying the Intermediate Carbon Material

The intermediate or “carbonized” carbon material is purified by removing at least a portion of non-graphitic amorphous carbon. This purification step increases the weight percent of carbon nanostructures in the intermediate carbon material.

The amorphous carbon is typically removed by oxidizing the carbon. The oxidizing agents used to remove the amorphous carbon are selective to oxidation of the bonds found in non-graphitic amorphous carbon but are less reactive to the pi bonds of the graphitic carbon nanostructures. The amorphous carbon can be removed by applying the oxidative agents or mixtures in one or more successive purification steps.

Optionally, substantially all or a portion of the catalytic metals can be removed. Whether the catalytic metal is removed and the extent to which it is removed will depend on the desired use of the carbon nanomaterial. In some embodiments of the invention, the presence of a metal such as iron can be advantageous for providing certain electrical properties and/or magnetic properties. Alternatively, it may be desirable to remove the catalytic metal to prevent the catalytic metal for having an adverse affect on its ultimate use. For example, it can be advantageous to remove the metal if the carbon nanostructures are to be used as a catalyst support material for a fuel cell. Removing the catalytic templating particles can also improve the porosity and/or lower its density.

Typically, the catalytic metals and/or templating nanoparticles are removed using acids or bases such as nitric acid, hydrogen fluoride, or sodium hydroxide. The method of removing the catalytic metals or amorphous carbon depends on the type of catalyst atoms in the composite. Catalyst atoms or particles (e.g., iron particles or atoms) can typically be removed by refluxing the composite nanostructures in 5.0 M nitric acid solution for about 3-6 hours.

Any removal process can be used to remove the catalytic metals and/or amorphous carbon so long as the removal process does not completely destroy the carbon nanostructures. In some cases it may even be beneficial to at least partially remove some of the carbonaceous material from the intermediate nanostructure during the purification process.

Optionally, the purification process can also include additional heat treatment steps at temperatures and conditions that can convert residual amorphous carbon to graphite. In this optional step, residual carbon is more easily converted to a graphitic material since a substantial portion of the amorphous carbon has been removed and there is better heat transfer to the portion that remains.

### IV. Carbon Nanostructures and Composite Materials

The methods of the present invention produce a carbon nanomaterial having multi-walled carbon nanostructures. The carbon nanostructures within the carbon nanomaterial have useful properties such as unique shape, size, and/or electrical properties. Reduced agglomeration of the carbon nanostructures is believed to be responsible for at least some of the beneficial and novel properties of the carbon nanomaterials of the invention.

The carbon nanostructures of the invention are particularly advantageous for some applications where high porosity, high surface area, and/or a high degree of graphitization are desired. Carbon nanostructures manufactured as set forth herein can be substituted for carbon nanotubes, which are typically more expensive to manufacture.

The carbon nanostructures can be regular or irregularly shaped spheroidal structures. In one embodiment, the carbon nanospheres have an irregular surface with graphitic defects that cause the nanospheres to have a shape that is not perfectly spherical. The inner diameter of the carbon nanostructures (i.e., the hollow center surrounded by a graphitic wall) can be between 0.5 nm to about 90 nm, more preferably between about 1 nm and about 50 nm.

The carbon nanomaterials of the invention can be characterized by their weight percent of carbon nanostructures. The weight percent of carbon nanostructures (e.g., nanospheres) in the carbon nanomaterial can be greater than 10%, preferably greater than 50%, and more preferably greater than 75%, and most preferably greater than 90%.

In many of the carbon nanostructures observed in TEM images, the outer diameter of the nanostructure is between about 10 nm and about 60 nm and the hollow center diameter is about 10 nm to about 40 nm. However, the present invention includes nanostructures having larger and smaller diameters. Typically, the carbon nanostructures have an outer diameter that is less than about 100 nm to maintain structural integrity.

The thickness of the nanostructure wall is measured from the inside diameter of the wall to the outside diameter of the wall. The thickness of the nanostructure can be varied during manufacture by limiting the extent of polymerization and/or carbonization of the carbon precursor as described above. Typically, the thickness of the carbon nanostructure wall is between about 1 nm and about 20 nm. However, thicker and thinner walls can be made if desired (e.g., less than about 15 nm, 10 nm, or 5 nm). The advantage of making a thicker wall is greater structural integrity. The advantage of making a thinner wall is greater surface area and porosity.

The wall of the carbon nanostructure can also be formed from multiple graphitic layers. In an exemplary embodiment, the carbon nanostructures have walls of between about 2 and about 100 graphite layers, preferably between about 5 and 50 graphite layers and preferably between about 5 and 20 graphite layers. The number of graphitic layers can be varied by varying the thickness of the carbon nanostructure wall as discussed above. The graphitic characteristic of the carbon nanostructures is believed to give the carbon nanostructures beneficial properties that are similar to the benefits of multi-walled carbon nanotubes (e.g., excellent conductivity). They can be substituted for carbon nanotubes and used in many applications where carbon nanotubes can be used but often with predictably superior results.

While the TEM images show nanostructures that are generally spherical, the present invention extends to nanostructures having shapes other than spheroidal. In addition, the nanostructures may be fragments of what were originally spheroidal shaped nanostructures.

In some embodiments, a majority of the carbon nanospheres by weight form agglomerates of less than 100 nanospheres, preferably less than 50 nanospheres, and more preferably less than 25 nanospheres. In some embodiments, a majority of the carbon nanospheres form agglomerates with a diameter of less than about 200 nm, preferably less than 100 nm, and more preferably less than 50 nm. As discussed more fully below with regard to Example 1 and as shown in the Figures, carbon nanospheres manufactured according to the methods described herein can exhibit substantially less agglomeration than carbon nanospheres manufactured using similar methods without the use of solvent extraction.

In addition to good electron transfer, the carbon nanostructures of the present invention can have high porosity and large surface areas. Adsorption and desorption isotherms indicate that the carbon nanostructures form a mesoporous material. The BET specific surface area of the carbon nanostructures can be between about 80 and about 400 m²/g, and is preferably greater than about 100 m²/g, more preferably greater than about 120 m²/g (e.g., between about 120 m²/g and about 300 m²/g), and typically about 200 m²/g, which is significantly higher than the typical 100 m²/g observed for carbon nanotubes. Even where the methods of the invention results in carbon nanostructures combined with non-structured graphite, this graphitic mixture (i.e., the carbon nanomaterial) typically has a surface area greater than carbon nanotubes. The high surface area and high porosity of the carbon nanostructures manufactured according to the present invention makes the carbon nanostructures useful for a variety of applications.

In one embodiment, the carbon nanomaterials are dispersible in a hydrophilic material, such as an aqueous solution. Examples of polar solvents that the carbon nanospheres can be dispersed in include, but are not limited to, water, lower alcohols (e.g., methanol, ethanol and/or isopropyl alcohol), THF, DMF, acetic acid, formic acid, trifluoroacetic acid, formamide, acetonitrile, NH₂—NH₂. One advantage of dispersing the carbon nanospheres in a polar solvent is that the carbon nanospheres can be more readily combined with some polymeric materials to form a composite.

The carbon nanospheres may also be combined with organic solvents including non-polar organic solvents. Examples of non-polar solvents include methylpyrrolidone (NMP), pyridine, 1-(3 aminopropyl)imidazoles, 1-Diethoxy methyl imidazoles, 1-2(hydroxyethyl)imidazoles, 4(1H-imidazole-1-yl)aniline, 4(imidazole 1-yl)phenol, barbituric acid, 1-methyl 2-pyrrolidinone hydrazone hydrochloride, quinoxaline, 1-ethyl-4-piperidone, 1-ethylpiperazine, ethyl 2-picolinate, or a combination thereof.

In one embodiment of the invention, the carbon nanospheres may be incorporated into a polymeric material to form a composite. The polymeric material used to make the composite can be any polymer or polymerizable material compatible with graphitic materials. Example polymers include polyamines, polyacrylates, polybutadienes, polybutylenes, polyethylenes, polyethylenechlorinates, ethylene vinyl alcohols, fluoropolymers, ionomers, polymethylpentenes, polypropylenes, polystyrenes, polyvinylchlorides, polyvinylidene chlorides, polycondensates, polyamides, polyamide-imides, polyaryletherketones, polycarbonates, polyketones, polyesters, polyetheretherketones, polyetherimides, polyethersulfones, polyimides, polyphenylene oxides, polyphenylene sulfides, polyphthalamides, polythalimides, polysulfones, polyarylsulfones, allyl resins, melamine resins, phenol-formaldehyde resins, liquid crystal polymers, polyolefins, silicones, polyurethanes, epoxies, polyurethanes, cellulosic polymers, combinations of these, derivatives of these, or copolymers of any of the foregoing. The polymerizable materials can be a polymer or a polymerizable material such as a monomer, oligomer, or other polymerizable resin.

The carbon nanospheres may be mixed with the polymeric material in a range of about 0.1% to about 70% by weight of the composite, more preferably in a range of about 0.5% to about 50% by weight, and most preferably in a range of about 1.0% to about 30%. The carbon nanospheres can be added alone or in combination with other graphitic materials to give the composite conductive properties. To impart electrical conductivity, it is preferable to add more than about 3% by weight of carbon nanospheres in the composite, more preferably greater than about 10% by weight, and most preferably greater than about 15%.

As a method for producing the composite of the present invention, any known method can be used. For example, pellets or powder of the polymeric material and a desired amount of the carbon nanospheres can be dry-blended or wet-blended and then mixed in a roll kneader while heated, or fed in an extrusion machine to extrude as a rope and then cut into pellets. Alternatively, the carbon nanospheres can be blended in a liquid medium with a solution or dispersion of the resin. When a thermosetting polymerizable material is used, the carbon nanospheres can be mixed with a monomer or oligomer using any known method suitable for the particular resin.

### V. Example

The following example provides a formula for making carbon nanomaterials containing carbon nanostructures according to the present invention.

### Example 1

Example 1 describes the preparation of an intermediate carbon nanomaterial having carbon nanospheres.

(a) Preparation of Precursor Solution

A 0.2 M iron polymeric complex solution was prepared using 56 g iron powder, 193 g of citric acid (1:1 molar ratio), and 5 L of water. The iron-containing mixture was vigorously stirred and air purged in a 10 L glass reactor. After 24 hours, a clear greenish-yellow solution was obtained and used as is for the carbon nanomaterial synthesis.

(b) Polymerization

61 g of resorcinol and 90 g of formaldehyde were placed in a 1 L flask. The solution was stirred until resorcinol was fully dissolved. 500 ml of the precursor solution prepared in step (a) was slowly added under agitation. Polymerization was induced by slowly adding 60 ml of ammonium hydroxide with vigorous stirring; the pH of the resulting suspension was ˜10. The slurry was cured at 80-90° C. for 3 hours. The wet solid polymer was collected by filtration, without drying.

(c) Solvent Extraction

50 g of the wet polymer and 200 ml of butanol were added to a three-neck round bottom flask with one neck equipped with mechanical stirring, one neck with a stopper, and one neck with a separation funnel which was connected to a refluxing tube. The resulting slurry of wet polymer and butanol was heated at 110° C. with vigorous stirring. As the reaction proceeded, two layers formed in the separation funnel: the top layer was determined to be butanol and the bottom layer was water extracted from the polymer. The bottom layer was periodically removed. The extraction was allowed to continue until no additional water was being produced, thereby indicating all the water in the polymer had been fully extracted by the butanol. Thereafter, excess butanol was removed by rotary evaporation with vacuum. After this treatment, the surface of the polymer was coated with butanol.

(d) Carbonization

The extraction-treated polymer was placed in crucibles and covered with a crucible plate and transferred to a furnace for carbonization. The carbonization process was conducted under ample amount of nitrogen flow and carried out under the temperature program as follows: heating to 1050° C. at 20° C./min, holding at 1050° C. for 5 hrs, and cooling to room temperature. The carbonization yielded a carbon nanomaterial intermediate that included carbon nanospheres.

(d) Purification

The carbon nanomaterial intermediate was refluxed in 5M HNO₃ for 6 hours followed by treating in 4M HCl at 90° C. for 6 hrs. The purified carbon nanomaterial was washed with ample amounts of water until the pH reached ˜5. The purified carbon nanomaterial was then collected and dried in an oven overnight at 80° C.

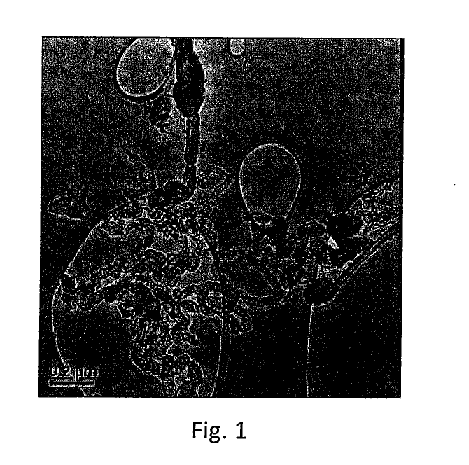

FIG. 1 is a TEM image taken of the carbon nanomaterial manufactured according to Example 1. As can be seen in the TEM image, the carbon nanomaterial manufactured according to Example 1 includes a majority of well dispersed, non-agglomerated carbon structures.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A method for manufacturing a carbon nanomaterial, comprising,
providing a mixture including a carbon precursor and a catalytic metal and polymerizing the mixture to form a polymerized carbon material;
extracting water from the polymerized carbon material using an organic solvent to yield an extraction-treated carbon material;
carbonizing the extraction-treated carbon material to form an intermediate carbon material comprising a plurality of carbon nanostructures, amorphous carbon, and catalytic metal; and
purifying the intermediate carbon material by removing at least a portion of the amorphous carbon and at least a portion of the catalytic metal.

2. A method as in claim 1, wherein the step of extracting water includes preparing a slurry of the polymerized carbon material and the organic solvent.

3. A method as in claim 2, further comprising heating the slurry to accelerate formation of an aqueous phase and an organic phase.

4. A method as in claim 3 wherein the heating is carried out until additional formation of the aqueous phase ceases.

5. A method as in claim 3, wherein the slurry is refluxed.

6. A method as in claim 3, wherein the slurry is heated to a temperature in a range from about ** to about **.

7. A method as in claim 1, wherein the organic solvent is not miscible in water.

8. A method as in claim 1, wherein the organic solvent has a solubility parameter in water of less than 12.5 g/ml at 20° C.

9. A method as in claim 1, wherein the organic solvent comprises butanol.

10. A method as in claim 1 further comprising drying the extraction-treated carbon material to remove the organic solvent used in the extraction.

11. A method as in claim 10, further comprising applying fresh organic solvent to the surface of the extraction treated carbon material.

12. A method as in claim 1 wherein the carbon precursor comprises a member selected from the group consisting of resorcinol, phenol resin, melamine-formaldehyde gel, poly(furfuryl alcohol), poly(acrylonitrile), and petroleum pitch.

13. A carbon nanomaterial manufactured according to the method of claim 1.

14. A composite material comprising the carbon nanomaterial of claim 10 and a polymeric material.

15. A method for manufacturing a carbon nanomaterial, comprising,
providing a mixture including a carbon precursor and a catalytic metal and polymerizing the mixture to form a polymerized carbon material;
extracting water from the polymerized carbon material using an organic solvent to yield an extraction-treated carbon material, wherein extracting the water includes,
preparing a slurry of the organic solvent and the polymerized carbon material;
heating the slurry to form an aqueous phase and an organic phase and continuing the heating until formation of additional aqueous phase ceases;
removing the aqueous phase and the organic phase from the polymeric carbon material to yield the extraction-treated carbon material;
carbonizing the extraction-treated carbon material to form an intermediate carbon material comprising a plurality of carbon nanostructures, amorphous carbon, and catalytic metal; and
purifying the intermediate carbon material by removing at least a portion of the amorphous carbon and at least a portion of the catalytic metal.

16. A method as in claim 15, wherein the step of heating the slurry includes refluxing.

17. A method as in claim 15, further comprising drying the extraction-treated carbon material and coating the surface thereof with fresh organic solvent.

18. A method as in claim 15, wherein the organic solvent includes an organic alcohol of at least 4 carbon atoms.

19. A carbon nanomaterial manufactured according to the method of claim 15.

20. A composite material comprising the carbon nanomaterial of claim 19 and a polymeric material.
